(19) United States
(12) Patent Application Publication
(10) Pub. No.: US 2003/0114972 A1
(43) Pub. Date: Jun. 19, 2003

(54) Vehicle occupant protection apparatus

(76) Inventors: Tetsuya Takafuji, Anjo-city (JP); Tomoji Suzuki, Nagoya-city (JP)

Correspondence Address: POSZ & BETHARDS, PLC, 11250 ROGER BACON DRIVE, SUITE 10, RESTON, VA, 20190, US

(21) Appl. No.: 10/234,108

(22) Filed: Sep. 5, 2002

(30) Foreign Application Priority Data
Dec. 18, 2001 (JP) 2001-384848

(51) Int. Cl. G06F 7/00

(52) U.S. Cl. 701/45

(57) ABSTRACT

A vehicle occupant protection apparatus includes a collision object data detection element on a vehicle to detect data, such as the physical parameters of the estimated collision object related to a collision impact force, from an estimated collision object, a vehicle-onboard occupant protection element activated in the event of a vehicle collision, thereby protecting an occupant in a predetermined activation mode, and a protection mode control element for changing the activation mode based on the data. The vehicle occupant protection apparatus may also utilize a collision detection element for detecting an actual collision with the estimated collision object.

### CROSS REFERENCE TO RELATED APPLICATION

This application is based upon, claims the benefit of priority of, and incorporates by reference the contents of prior Japanese Patent Application No. 2001-384848 filed Dec. 18, 2001.

### BACKGROUND OF THE INVENTION

1. Field of the Invention

The present invention relates to a vehicle occupant protection apparatus. More specifically, the invention relates to evaluation of potential vehicle impact objects, using onboard physical data and characteristics pertaining to the impact objects, to protect a vehicle occupant using a protection apparatus that utilizes the onboard data in the event of an impact with the impact object.

2. Description of the Related Art

Japanese Patent Laid-Open Publication No. Hei. 06-160516 discloses technology for determining the degree of danger based on the type and the position of the center of gravity of an object image extracted from a reflected image provided from a two dimensional, onboard, vehicular radar apparatus.

Japanese Patent Laid-Open Publication No. 2000-71929 discloses technology for controlling activation of an occupant protector based on the acceleration of a vehicle involved in a vehicle collision.

It is preferable to change the activation of an occupant protector according to the degree of an impact force in a collision. However, an impact applied to an occupant when a vehicle collides, or an impact applied to the occupant when the occupant collides with the vehicle (such as a secondary impact from a secondary collision of the occupant with a windshield) largely depends on the individual masses and stiffness of the vehicle and collision object in addition to a relative acceleration between the vehicle and the collision object. In extreme cases, when the collision object is a large vehicle or a rock, the collision impact is extremely large. On the other hand, when the collision object is a flag or a small, flat, plate-like sign, a collision impact force is much smaller and barely generated. Consequently, it is important to change the activation mode of the occupant protector based on the mass and the stiffness of the collision object.

Thus, it has been proposed to install an acceleration sensor, hereinafter referred to as a G sensor, on a vehicle for detecting impact acceleration during a collision. Accordingly, it is possible to adjust the activation mode of an occupant protector such as an airbag based on the detected collision impact acceleration. However, the occupant protection technology using the G sensor can detect the impact force in a collision only after the collision actually occurs. Therefore, changing the activation mode of the occupant protector before an impact is not possible.

Further, when a vehicle collides with a pole-like object, such as an electric or telephone pole, since acceleration may not be transmitted to a vehicle system or device until just after a collision, the activation of the occupant protector using the G sensor is delayed and is effectively useless. Additionally, the technologies proposed in the above publications do not refer to the importance of early estimation of the mass and stiffness of the collision object, and the importance of estimation of the impact force in a collision based on the estimated mass and stiffness.

### SUMMARY OF THE INVENTION

The present invention has been devised in view of the foregoing, and has the object of providing a vehicle occupant protection apparatus for optimally protecting an occupant, without a time delay, in accordance with the degree of an impact force generated in a vehicle collision.

A vehicle occupant protection apparatus according to the present invention comprises a collision object data detection element which is provided on a vehicle, which detects data pertaining to a collision impact force from an estimated collision object, a vehicle-onboard occupant protection element which is activated in the event of a vehicle collision, thereby protecting an occupant in a predetermined activation mode, and a protection mode control element for changing the activation mode based on the data. Namely, with the present invention, since the data regarding the collision impact force is collected from the estimated collision object before an actual collision, and then the activation mode of the occupant protection apparatus such as an airbag is selected based on the collected data, the occupant is optimally protected without delay according to the degree of the impact force generated in the vehicle collision.

In more detail, when an area image sensor, an ultrasonic apparatus, or an electromagnetic wave apparatus is used to estimate a collision in advance, it is possible to activate an occupant protection apparatus if the collision is unavoidable. However, when the apparatus for early activation of the occupant protection apparatus is used, the occupant protection apparatus is activated before the actual collision. Thus, when the collision object is a very soft object, or a very light object, the occupant protection apparatus may apply a larger impact to an occupant than the actual collision impact without such a system. This problem commonly exists in all conventional occupant protection apparatuses which estimate collision impact forces.

It is also possible to activate the occupant protection apparatus after a fairly large impact is actually detected by a G sensor, for example, or to change the activation mode of the occupant protection apparatus according to an impact pattern actually generated. However, in these cases, since the actual impact has already been generated, though the occupant protection apparatus may be activated without a large delay, there is not enough time for such a process as adjusting the activation mode of the occupant protection apparatus according to the impact pattern. With the present invention, since data on the collision impact force is collected regarding the collision object before a collision, and then, the activation mode, optimal for the collision impact force estimated based on the data, is selected for the occupant protection apparatus, such problems are solved all at once.

In a first aspect of the present invention, the data of the estimated collision object includes the type of the estimated collision object, and the relative speed of the subject vehicle with respect to the estimated collision object. The subject vehicle is the vehicle that is to protect the occupant. The present invention is to be installed within the subject vehicle, therefore future discussion may pertain to a subject vehicle. When the type of the estimated collision object is obtained, it is possible to estimate the mass and the stiffness (tendency of deformation or tendency of displacement) of the estimated collision object. As a result, since the degree of the collision impact force is determined based on the mass, the stiffness, and the relative speed of the estimated collision object, it is possible to select the optimal activation mode according to the degree of the collision impact force.

In this embodiment, based on the type and the relative speed of the estimated collision object, the optimal activation mode may be directly selected in advance from a map storing the activation modes. In another way, the collision impact force may be determined from the type and the relative speed of the estimated collision object, and then the optimal activation mode may be selected based on the map storing the activation modes. In yet still another way, the collision impact force may be calculated or searched from a map based on the mass and the stiffness obtained from the type of the estimated collision object and the relative speed of the estimated collision object.

In a preferred embodiment of the present invention, the protection mode control element changes an activation timing or an activation level of the occupant protection element such as an airbag based on the detected data, the determined type of the estimated collision object, or the estimated collision impact force. With this constitution, the activation mode is easily changed.

In a preferred embodiment of the present invention, the vehicle occupant protection apparatus further comprises a collision detection element for detecting an actual collision with the estimated collision object. The protection mode control element activates the occupant protection element based on the changed activation mode when an actual collision is detected. With this constitution, since the occupant protection element is activated in the selected activation mode after an actual collision is detected, that is, anticipated, it is possible to reduce the probability of generating an operation error.

In a preferred embodiment, the collision object data detection element detects the shape of the estimated collision object as the data on the type of the estimated collision object, and determines the type of the estimated collision object based on the shape of the estimated collision object. Thus, the type of the estimated remote collision object is easily determined. For example, the collision object data detection element includes an area image sensor for imaging the estimated collision object, and determines the type of the estimated collision object based on an image signal provided from the area image sensor.

In a preferred embodiment of the present invention, the collision object data detection element uses the image signal from the area image sensor to determine a relative speed with respect to the estimated collision object. Thus, since this area image sensor has both, the function for detecting the data on the type of the estimated collision object, and the function for detecting the relative speed of the estimated collision object, the system is simplified.

In the present invention described above, it is also possible to provide a collision estimation element for estimating the probability of the collision with the estimated collision object, thereby letting the protection mode control element activate the occupant protection element based on the changed activation mode when the collision probability is larger than a predetermined value. In this case, since the occupant protection apparatus is activated before an actual collision, it is possible to increase control capability and occupant protection capability of the occupant protection apparatus. As the collision estimation element, means for using the image signal from the area image sensor for determining the type of the estimated collision object is adopted for estimating a collision. Technology for activating an occupant protection apparatus early based on detecting a collision in advance is, to a limited degree, publicly known.

### BRIEF DESCRIPTION OF THE DRAWINGS

FIG. 1 is a block diagram showing an embodiment of an occupant protection apparatus of the present invention;

FIG. 2 is a block diagram showing the collision object data detection apparatus shown in FIG. 1;

FIG. 3 is a flowchart showing an example of an image processing operation of the collision object data detection apparatus shown in FIG. 1;

FIG. 4 is a flowchart showing an example of a control operation of a control apparatus shown in FIG. 1;

FIG. 5 is a flowchart showing another example of the control operation of the control apparatus shown in FIG. 4.; and

FIG. 6 is a flowchart specifically describing an activation mode selection operation of the control apparatus shown in FIG. 4.

### DETAILED DESCRIPTION OF THE PREFERRED EMBODIMENT

The following will describe preferred embodiments of a vehicle occupant protection apparatus of the present invention.

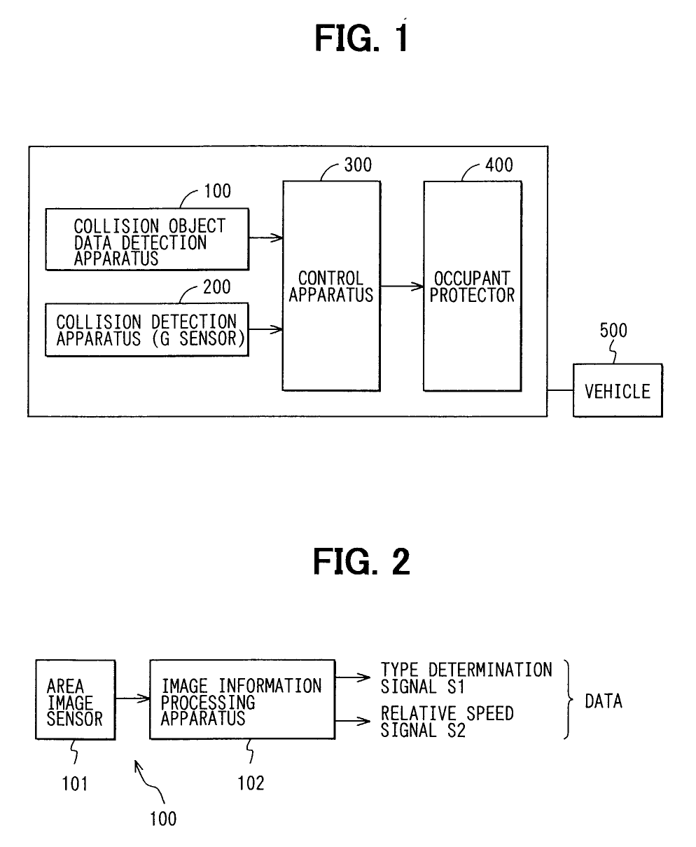

FIG. 1 is a block diagram showing a relationship among individual functional elements constituting an occupant protection apparatus of a first embodiment of the present invention.

The occupant protection apparatus of the present embodiment includes a collision object data detection apparatus (a collision object data detection element) 100, a collision detection apparatus (a collision detection element) 200, a control apparatus (a protection mode control element) 300 for controlling an occupant protector based on signals provided from these detection apparatuses, and the occupant protector (an occupant protection element) 400 for controlling inflation of an airbag (not shown) according to an inflation timing schedule and an inner pressure of the airbag determined by the control apparatus 300.

The following will describe the collision object data detection apparatus (the collision object data detection element) 100 while referring to a block circuit diagram shown in FIG. 2. The collision object data detection apparatus 100 comprises an infrared area image sensor 101, and an image information processing apparatus 102. The image information processing apparatus 102 processes a two-dimensional image signal periodically provided from the infrared area image sensor 101 to extract an estimated collision object, and extracts the type and the relative speed of the extracted estimated collision object. Then, the apparatus 102 provides the control apparatus 300 with the type and the relative speed of the estimated collision object as a type determination signal S1, and a relative speed signal S2.

As the collision object data detection apparatus 100, various sensing means for scanning an area ahead of a vehicle to remotely sense the shape of the estimated collision object may be adopted in place of the area image sensor. As this type of sensing means, an ultrasonic radar system, or an electromagnetic wave radar system may be adopted. The infrared area image sensor 101 is provided on a front surface of the vehicle to image the area ahead of the vehicle. For imaging at night, imaging may be conducted continuously or at predetermined intervals while an infrared projector lamp is provided on the front surface of the vehicle. In place of the infrared area image sensor 101, a visible-light area image sensor may be adopted. In this case, the visible-light area image sensor may image a reflected component of infrared light or visible light projected from a head lamp at night. Though it is preferable to constitute the image information processing apparatus 102 with a type of digital signal processor, it is clear that a dedicated image processing circuit apparatus or a general purpose microcomputer may constitute the image information processing apparatus 102.

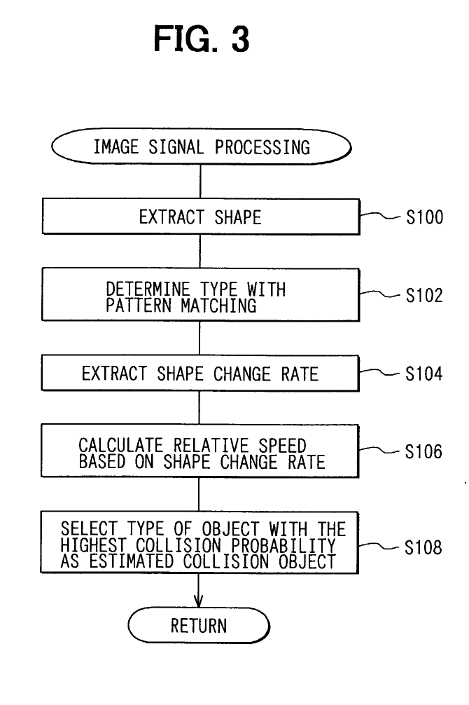

The following will describe an example of image processing executed by the image information processing apparatus 102 while referring to a flowchart shown in FIG. 3. First, after a two-dimensional image signal provided from the area image sensor 101 is converted into a digital image signal corresponding to the magnitude of individual pixel signals, contour extraction is conducted to extract an outline shape (the outermost contour) (S100). The contour extraction, the outline shape extraction, and their variations conducted in this step are already publicly known in the field of the image recognition technology. Since specific details of this shape extraction are not the subject of the present invention, further description is not provided. Of course, it is possible to process different types of additional data such as a color, a texture, and a detail shape for increasing the precision of type recognition conducted later in addition to simply extracting the outline shape of the object ahead of the vehicle.

Then, types of the individual extracted outline shapes are determined (S102). More specifically, the image information processing apparatus 102 has a database for determining individual outline shapes which may be imaged and extracted. The extracted individual outline shapes are given names corresponding to the closest shapes from the many outline shape models stored in this database. This type determination processing corresponds to image processing usually known as pattern matching. Typical outline shape models include a large vehicle, a two-wheeled vehicle, a small vehicle, a human, a small animal, a building, and a pole. It is clear that these outline shape models are different in mass, stiffness, and collision impact force when applied to a colliding vehicle.

Then, rates of change of the shapes are measured for the individual types (the objects) (S104). Based on the measured result, relative speeds between the vehicle and the objects are calculated (S106). More specifically, when increased rates of area of a prescribed part of the individual outline shapes are obtained, for example, these rates are information relevant to the relative speeds. Alternatively, when the sizes of the individual types of the objects are stored in advance, it is possible to estimate the current distances to the objects based on the size on an imaging screen, an optical reduction ratio of the area image sensor 101, and the actual size. Then, the relative speeds are detected based on the rates of decrease of the distances.

Alternatively, other dedicated distance sensors may be provided, or two area image sensors may be provided to calculate the relative speed based on a change rate of the distance obtained with triangulation. As another simplified method, standard speeds are uniformly given to the individual types (the objects) which have already been obtained before, and then, the relative speeds are obtained from the standard speeds of the individual types (the objects) and the vehicle speed. For example, it may be assumed that the human, the small animal, and the pole are stationary, and the vehicle is approaching at a certain speed. Since the determination of the relative speeds is not the indispensable requirement of the present invention, it is possible to estimate the collision impact force based on the type (the object) and the vehicle speed instead.

Then, collision probability is decided for the individual determined types, that is, the objects. As a result, the type (the object) with the highest collision probability is selected as an estimated collision object (S108), and the type and the relative speed of the estimated collision object are provided for the control apparatus 300.

The collision detection apparatus (the collision detection element) 200 comprises a G sensor in the present embodiment, detects a large change in the vehicle acceleration in a collision, thereby determining the collision, and then reports to the control apparatus 300 of the collision. It is also possible to process the output image from the area image sensor for determining whether a collision is unavoidable or not, and then to report to the control apparatus 300 of the generation of the unavoidable accident.

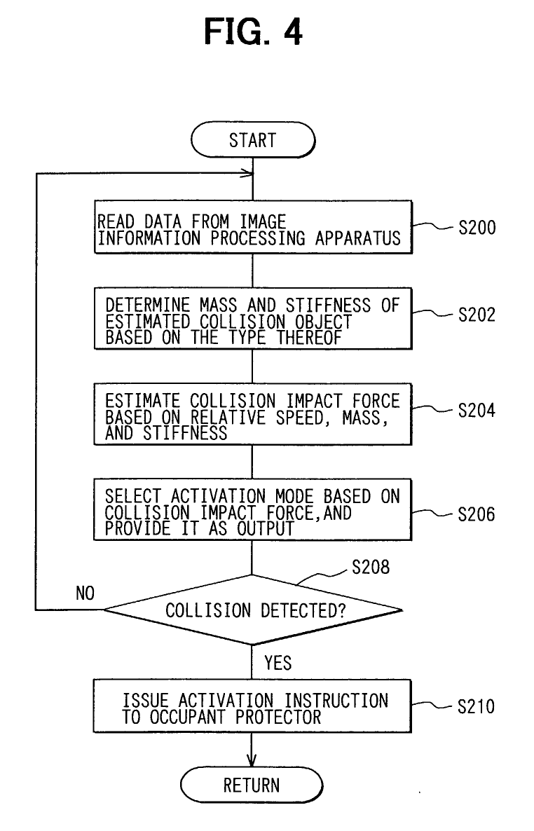

The control apparatus 300 comprises a microcomputer apparatus, and determines an optimal activation mode for the occupant protector 400 based on entered data when a collision is detected. The following section describes an example of a control operation of the control apparatus 300 while referring to FIG. 4.

First, the control apparatus 300 reads the data, namely the type and the relative speed of the estimated collision object, from the image information processing apparatus 102 (S200). The control apparatus 300 determines the mass and the stiffness of the estimated collision object based on the type of the estimated collision object contained in the read data (S202). For this determination, the control apparatus 300 may store standard masses and standard stiffnesses for individual estimated collision objects as a map, and may read out the masses and stiffnesses for the entered individual estimated collision objects. Alternatively, such a parameter as a repulsive force may be stored as a particular quantity including mass and stiffness in advance, and the parameter may be read out.

Then, the determined mass, stiffness, and relative speed of the estimated collision object are used to refer to a map for determining the collision impact force (S204). This map stores in advance relationship between the mass, the stiffness, and the relative speed, and the collision impact force as a table. It is apparently possible to assign the mass, the stiffness, and the relative speed to a stored equation for calculating the collision impact force, thereby obtaining the collision impact force.

Then, the obtained collision impact force is used to refer to a map stored in advance for determining the activation mode of the occupant protector (S206). In the next step, the control apparatus 300 determines whether the collision detection apparatus 200 has detected a collision or not (S208). The selected mode is provided for the occupant protector 400 when a collision occurs (or the collision is unavoidable) (S210). This map stores a large number of pairs of a collision impact force and the activation mode optimal for this collision impact force. In the present embodiment, the individual activation modes comprise a pair of the activation timing of the passenger protector 400 and the inner pressure level of the air bag (see FIG. 6).

For example, the inner pressure of the air bag increases when a head-on collision with an object such as a passenger vehicle, a large vehicle, or an electric pole approximately as heavy as, or heavier than the subject vehicle. Further, in this type of collision, it is preferable to advance the activation timing since the impact force increases rapidly.

In a collision where a collision object is a passenger vehicle approximately as heavy as the subject vehicle but one in which the collision is offset, or the collision is on a side surface of the object vehicle, for example, since the impact force gradually increases, it is preferable to increase the inner pressure level as in the case described above, and to delay the activation timing to alleviate any impact applied to an occupant. In a collision with an object such as a two-wheeled vehicle or a small animal lighter than the subject vehicle, since the impact force is small, it is preferable to decrease the inner pressure level, and to adjust the activation timing as the estimated impact force increases.

With the embodiment described above, the airbag is optimally inflated according to the degree of a collision impact force estimated before a collision. The optimal activation mode may be directly selected based on the type and the relative speed of an estimated collision object, or only based on the type of the estimated collision object. Namely, with this embodiment, since the data of the collision impact force is collected from an estimated collision object before the collision actually occurs, and then the activation mode of the occupant protector such as an airbag is selected based on the data, an occupant is optimally protected without delay according to the impact force generated in a vehicle collision.

(Modified Embodiment)

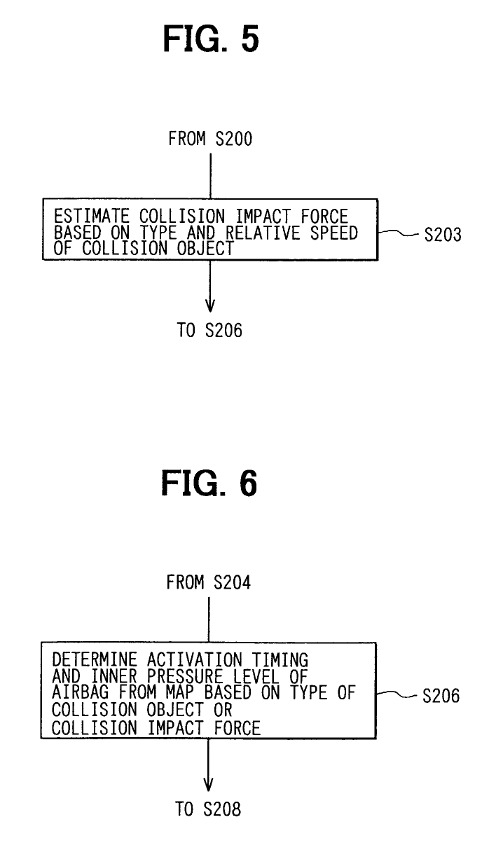

The following will describe a modification of the embodiment above while referring to FIG. 5. A step S203 in FIG. 5 replaces steps S202 and S204 in FIG. 4, and estimates the collision impact force based on the type and the relative speed of the estimated collision object. Namely, in this modification, the processing of the parameters such as the mass and the stiffness is eliminated

What is claimed is:

1. A vehicle occupant protection apparatus comprising:
a collision object data detection element provided on a vehicle, the collision object data detection element for detecting data with respect to a collision impact force from an estimated collision object;
a vehicle occupant protection element activated in the event of a vehicle collision, thereby protecting an occupant in a predetermined activation mode; and
a protection mode control element for changing the activation mode based on the data.

2. The vehicle occupant protection apparatus according to claim 1, wherein the data includes a type of the estimated collision object and a relative speed with respect to the estimated collision object.

3. The vehicle occupant protection apparatus according to claim 1 or claim 2, wherein the protection mode control element estimates a degree of the collision impact force based on the entered data, and selects the activation mode optimal for a degree of the present collision impact force based on relationship information representing a relationship between the collision impact force stored in advance, the optimal activation mode of the occupant protection element, and the result of the estimation.

4. The vehicle occupant protection apparatus according to claim 3, wherein the protection mode control element changes an activation timing of the occupant protection element based on the detected data.

5. The vehicle occupant protection apparatus according to claim 3, wherein the protection mode control element changes an activation level of the occupant protection element based on the estimated collision impact force.

6. The vehicle occupant protection apparatus according to claim 1, further comprising a collision detection element for detecting an actual collision with the estimated collision object, wherein the protection mode control element activates the occupant protection element based on the changed activation mode when an actual collision is detected.

7. The vehicle occupant protection apparatus according to claim 5, further comprising a collision detection element for detecting an actual collision with the estimated collision object, wherein the protection mode control element activates the occupant protection element based on the changed activation mode when an actual collision is detected.

8. The vehicle occupant protection apparatus according to claim 1, wherein the collision object data detection element detects a shape of the estimated collision object as the data on a type of the estimated collision object, and determines the type of the estimated collision object based on the shape of the estimated collision object.

9. The vehicle occupant protection apparatus according to claim 8, wherein the collision object data detection element includes an area image sensor for imaging the estimated collision object, and determines the type of the estimated collision object based on an image signal provided from the area image sensor.

10. The vehicle occupant protection apparatus according to claim 9, wherein the collision object data detection element uses the image signal from the area image sensor to determine a relative speed with respect to the estimated collision object.

11. A method of controlling a vehicle occupant protection apparatus, comprising the steps of:
providing a collision object data detection element on a vehicle;
detecting data using the data detection element with respect to a collision impact force from an estimated collision object;
activating a vehicle occupant protection element in the event of a vehicle collision with the estimated collision object, thereby protecting a vehicle occupant in a predetermined activation mode; and
providing a protection mode control element for changing the activation mode based on the data.

12. The method of controlling a vehicle occupant protection apparatus of claim 11, further comprising the step of:
including a type of the estimated collision object and a relative speed with respect to the estimated collision object, in the data.

13. The method of controlling a vehicle occupant protection apparatus of claim 12, further comprising the step of:
estimating, by the protection control element, a degree of the collision impact force based on the entered data.

14. The method of controlling a vehicle occupant protection apparatus of claim 13, further comprising the step of:
selecting, by the protection control element, the activation mode optimal for a degree of the present collision impact force based on relationship information representing a relationship between the collision impact force stored in advance, the optimal activation mode of the occupant protection element, and the result of the estimation.

15. The method of controlling a vehicle occupant protection apparatus of claim 14, wherein the protection mode control element changes an activation timing of the occupant protection element based on the detected data.

16. The method of controlling a vehicle occupant protection apparatus of claim 15, wherein the protection mode control element changes an activation level of the occupant protection element based on the estimated collision impact force.

17. The method of controlling a vehicle occupant protection apparatus of claim 11, wherein the collision object data detection element detects a shape of the estimated collision object as the data on a type of the estimated collision object, and determines the type of the estimated collision object based on the shape of the estimated collision object.
